(19) United States
(12) Patent Application Publication
(10) Pub. No.: US 2005/0033623 A1
(43) Pub. Date: Feb. 10, 2005

(54) Method for producing a custom book and custom book obtained thereby

(76) Inventor: Eduardo Zemborain, Buenos Aires (AR)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/850,863

(22) Filed: May 21, 2004

(30) Foreign Application Priority Data
May 23, 2003 (AR) 030101808

(51) Int. Cl. G06F 17/60

(52) U.S. Cl. 705/8

(57) ABSTRACT

A method of producing a customized book and the resulting book. The book contains a plurality of different pieces about the recipient and is compiled by different people. The book can be given as a gift to the recipient, for example, on occasion of a birthday. The book production process can be led by a project manager. An originator of the book can appear as the author of the book. The process can be guided by a project manager through the Internet and by e-mail. The project manager can compile the pieces alluding the gift recipient sent by the gift recipient's relatives, friends and associates. The process employs a methodology that maximizes the number of collaborators to prepare material for the book.

### FIELD OF THE INVENTION:

The present invention relates to a method of producing custom literary works, and more particularly, to the literary works produced thereby.

### BACKGROUND OF THE INVENTION

Books are typically written by professional authors. Most books are written by a single writer, although there are a large variety of books where several authors collaborate. There are books where each chapter is written by a different author and then all the chapters are compiled by an editor into a single work. This is, typically, the case of handbooks and science and technology encyclopedias.

In all cases, the work adheres to a story line or table of contents, which each author follows in each of the sections planned. Each author is invited or selected taking into account his/her particular thorough knowledge of or expertise in the designated subject-matter. The inventor is not aware of any process intended to generate a literary work where the authors or collaborators are not selected personally, but randomly as a response to a general open invitation.

On the other hand, the target market of books is generally predetermined, whether educational in the case of school or college text books, intellectuals in the case of philosophy essays, or the general public in the case of novels and fiction and non-fiction works, such as biographies of famous people.

Almost all books are purchased or given as gifts based on the belief that by reading it the reader will increase or broaden his/her knowledge or views or will be amused. No books are known whose main value is in the field of emotions or feelings of a specific person or very small group of people, which are irrelevant for the general public.

### SUMMARY OF THE INVENTION

The disclosure is directed to a method of producing a personal literary work for a recipient such as, for example, for a special occasion.

In accordance with one or more embodiments, there is provided a method for producing a custom literary work to be presented on a predetermined delivery date to a recipient, which recipient may be an individual or a group of individuals. The method comprises receiving from an originator an order to produce said literary work and fixing a deadline for the reception of collaborations prior to the predetermined delivery date. The method can also comprise jointly with the originator, identifying and selecting a plurality of potential collaborators associated with said recipient, and sending out a general invitation to the selected potential collaborators requesting them to contribute literary pieces or other types of material related to the gift recipient. The method further comprises receiving the material from at least one of said collaborators in response to said general invitation. The method can also comprise after the reception of material from at least one of the collaborators and before said deadline, sending a notice to at least one of the potential collaborators from whom no reply has been received as yet, informing them of the articles received from other collaborators. The method can also comprise repeating the act of sending out the notice at least once more on a date close to said deadline to the potential collaborators who have not sent anything yet. The method can also comprise designing the layout of the literary work with material that includes a title alluding to the gift recipient and the originator's name. The method also comprises before the deadline, setting up, assembling and mounting the literary work with all the material received delivering the finished literary work to said originator.

In accordance with one or more embodiments, there is provided a literary work obtained in accordance with the above-described method, wherein the literary work comprises a plurality of articles related to the gift recipient's life, experiences, interests and tastes, with each piece having a different author.

In accordance with one or more embodiments, there is provided a method for producing a custom literary work to be presented on a predetermined delivery date to a recipient. The method comprises the acts of receiving an order to produce said literary work, fixing a deadline for the reception of collaborations prior to the predetermined delivery date, identifying and selecting a plurality of potential collaborators associated with said recipient, and sending a general invitation to the potential collaborators requesting them to contribute material related to the recipient. The method also comprises the acts of sending a notice to at least one of the potential collaborators from whom no reply has been received, receiving material from at least one of said collaborators setting up and assembling the literary work with at least some of the material received, and delivering the finished literary work.

In accordance with one or more embodiments, there is provided a custom literary work comprising a plurality of articles related to the recipient's life, experiences, interests and tastes, with each article having a different author.

### BRIEF DESCRIPTION OF THE DRAWINGS

The manner in which these and other objects and advantages of this disclosure are put into practice will be clearly evidenced by reference to the following detailed description of the preferred embodiments of this disclosure, which are merely examples and in no way a limitation, and to the attached drawings where:

FIG. 1 is a flow chart of a process to obtain a gift book according to the invention;

FIG. 2 is a view of the book generated by the process of FIG. 1 after binding and ready for being presented; and,

FIG. 3 is a view of the book of FIG. 2, in an open position, showing two of the many possibilities available for designing the layout of each article or chapter.

### DETAILED DESCRIPTION OF THE DRAWINGS

For purposes of describing the various embodiments of this disclosure, the following definitions are provided to explain the used terminology. The definitions do not, however, limit the scope of this disclosure in any way and it is to be appreciated that items outside of the provided definitions that can be considered to be within the definition according to one of skill in the art, are intended to be so.

“Art work” is the assemblage of art and photographic elements that serve to illustrate and design the book. It includes photographs, drawings, documents, manuscripts as well as all materials and illustrations produced at the originator's request, such as drawings, caricatures, photomontage pieces, collages, cartoons, etc.

“Book” is a printed product resulting from the compilation, editing and design of contents and art work obtained as a result of the process of this disclosure.

“By-products” are any and all products deriving from the information that the project manager obtains for a product. Some examples of this are: additional book copies, posters, t-shirts, invitations, reproductions, albums, brochures, etc.

“Collaborators” (co-authors, invitees) are those individuals who are invited by the originator and/or the project manager, according to predetermined guidelines, to collaborate, write, narrate their common experiences with the gift recipient, in response to the motivation of being a part of this very special gift for that person (or group of persons).

“Content” is the collection of written or recorded materials contributed by any off the originator, the collaborators, or the project manager, such as interviews, information obtained through the Internet, etc. These contents need not be consistent with each other or understood fully by anyone other than the gift recipient.

“Deadline” is the last day for reception of material contributed by the collaborators, which date is notified in the invitation. It is to be appreciated, however, that the project manager can maintain extra days in reserve for possible “extensions”.

“Delivery date” is the date and time committed by the project manager for delivery the finished product.

“Disguised interview” is an interview of the gift recipient made under a pretext, for partial or total inclusion in the book.

“Extension” is a number of days after the deadline that can be granted to collaborators who are delayed and have not sent their pieces on time.

“Event” can be an occasion (a party, meeting, anniversary, achievement, unique experience, etc.) where the gift recipient is presented with the special book. Accordingly, it is to be appreciated that the project manager can fix the deadline in relation to the date of the event.

“Gift recipient” is the person or group of persons who will be receiving the special book.

“Initial interview” is a first working meeting between the originator, the seller and the contents team. In this meeting, for example, the originator can provide the project manager with the background of the occasion and persons around which the book will develop, and both parties may agree on the actions to be implemented and the material to be provided by the originator.

“Internal marketing campaign” comprises strategies and processes employed to induce and motivate the invitees to actively participate in the project in question.

“Interviews” are generally optional services that the project manager may offer to provide to obtain material or verbal testimonies from invitees who, for example, do not have access to the Internet, or may have writing difficulties such as, for example, elder persons or very young children.

“Invitation” is the first message which invites dialog between the collaborators and the project manager or the originator. This message may contain, for example, the guidelines and instructions proposed by the project either of the project manager and the originator to invite, communicate, motivate, encourage and instruct as to what is invited from them, and to define the length of time available for such collaboration.

“Letter of Intent” is a document conceptually describing the spirit of the book. The letter of intent may also contain, for example, a disclaimer of the project manager's responsibility to the product obtained, by which the originator is informed and accepts that the value of the book lies in its great emotional value and that it is not a commercial product, and that, therefore, even though the project manager will make his or her best efforts to produce the book, errors may appear, and that there will be no or limited recourse in such events.

“Method” is the series of instances and strategies applied by the project manager to manage the preparation of Content and material by collaborators.

“Motivation” is the collection of reasons that the project manager employs to induce collaborators to participate actively and enthusiastically in the production of copy and content.

“Optionals” comprises any services added to the original commission for making a custom book, which provide further value added. Examples of this are a better binding, leather-bound covers, a disguised interview, editing, art by request, a caricature, a special photomontage work, content typing, etc.

“Originator” (author) is the person who commissions the preparation of a special book to be presented to a person or group of persons, on occasion of an event. The originator may be the book's author. His/her role during the process may be to any of invite, facilitate, evaluate, decide, give his/her opinion about all the aspects of the desired product.

“Pattern” is the tentative structure of the book and may be generated, for example, by the originator and the project manager in their first meeting, for the purpose of arranging the content and to guide its contents. This pattern can however be adapted to any content that may be spontaneously suggested by the collaborators.

“Packaging” consists of all the additional elements used when delivering the book and which add to perception thereof as an object of value. For example, the book can be presented wrapped in a special paper inside a velvet-lined wooden box which, in turn, is wrapped in paper and tied with a silk ribbon.

“Period” is the optimum period of time that the project manager sets in order to make a book.

“Personalized messages” are the messages sent, after the Invitation, to a person or group of persons to encourage, guide, persuade, direct, help or contribute ideas to improve, hasten or obtain responses. The strategies used in these messages are implemented according to the progress and results of the process, adapted to each particular circumstance.

“Sponsors” are those who are willing to contribute financially to paying the costs inherent in the production of the book. They may be, for example, mentioned on a special page.

According to some embodiments, the method of this disclosure can be prompted by an upcoming event related to a specific person, generally a celebration (or, without limitation, other types of occasions, such as social, professional or even merely formal events). The theme of the book, developed by a wide diversity of collaborators, will be inspired by said person (the “gift recipient”). In the sequence of any embodiments of the process, however, this gift recipient is designated the first actor, but may be considered as the last one, because he/she typically appears after the work has been completed.

The second actor of this disclosure may be, for example, a person closely related to the gift recipient, such as the spouse or one or more of his/her children, who decide to give that person a gift of this kind. The second actor (the “Author/originator”) typically hires the services of the third actor, the “project manager”. The project manager is typically more than a publisher, as he/she is typically the person responsible for implementing the process, which starts when the work is ordered and ends with the delivery of the product, such as, the bound, gift-wrapped book. It is normally the goal of the project manager to deliver the product in advance of the established deadline. According to some embodiments of this disclosure, the product may include a cover that features a title making reference to the gift recipient, rather than to the occasion in question, and the name of the author, generally the close relative or friend who hired, i.e., commissioned the work. However, it is to be appreciated that the cover may also include other references, such as, the occasion in question, and the like.

The fourth actor, typically consisting of a group of people, comprises the other family members, friends and colleagues, i.e., persons who share an affinity with the gift recipient (the “collaborators”). According to some embodiments of this disclosure, said collaborators are methodologically induced to produce a text beyond their initial aspirations and above their own limitations in this respect. For example, according to some embodiments of this disclosure, a responsibility of the so-called project manager is to follow systematically steps of the herein disclosed method in order to maximize the literary productivity of these persons. According to some embodiments of this disclosure, the collaborators individual work will be developed separately and they may even not know the other participants, at least until the last steps of the process. However it is to be appreciated that some of the collaborators may act in concert and may know of each other prior to the final steps of the process.

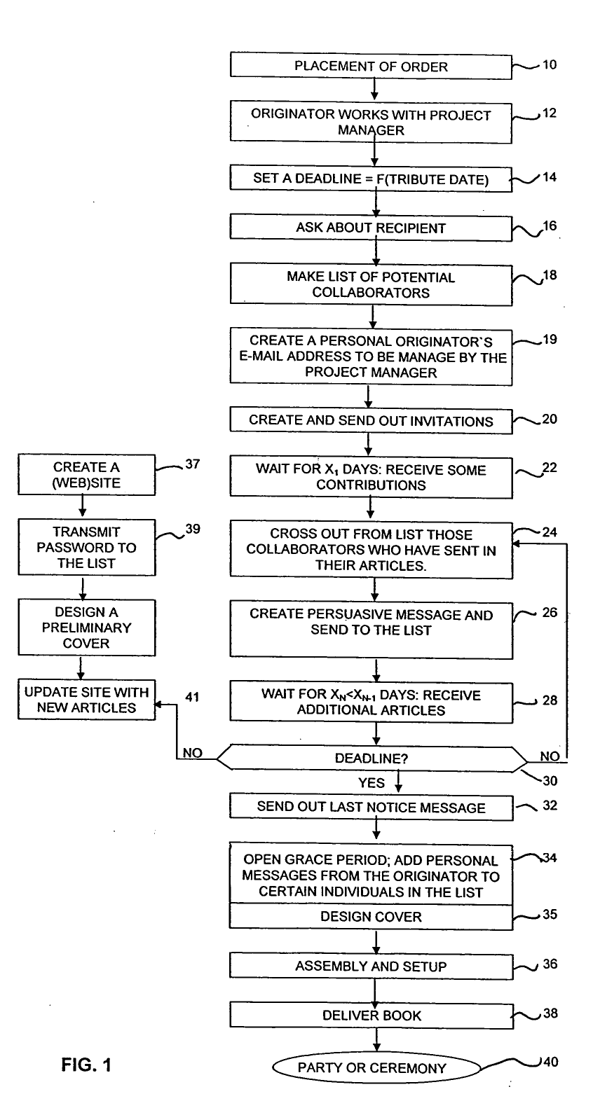

Referring now to FIG. 1, according to some embodiments of this disclosure, the first steps the process 100 of this disclosure can be the placement of the order by the originator (act 10), the execution of a letter of intent by the originator with the project manager (act 12), which can be followed by fixing of a deadline for submission of collaborations (act 14), which is typically set to be at least a few days before the date on which it will be presented to the gift recipient.

In subsequent steps, the project manager inquires about the personal interests, tastes, experiences and distinctive features of the gift recipient (act 16). Then, the originator and/or the project manager prepare a list of all other candidates that could cooperate as collaborators (act 18). Using, for example, personal communication media, e.g. e-mail messages, the project manager sends an Invitation (act 20), such as described herein, to all such potential collaborators for each of them individually to generate literary pieces related to the gift recipient. In order to communicate efficiently with the would-be collaborators and prevent being blocked by anti-spam e-mail systems, the project manager may create an e-mail address using the originator's name, so that would-be collaborators assume at first sight that the message originates from someone they know and trust, i.e. the originator. It is to be appreciated that according to some aspects of the disclosed process, irregardless of their response, the potential collaborators may be committed to secrecy so that the gift recipient will not find out about it.

It is to be appreciated that responses from the potential collaborators will be far from uniform, i.e., a few articles written by participants may be received early. For example, according to some embodiments of this disclosure, the process may comprise waiting a few days for responses from potential collaborators and may include receipt of some responses (act 22). Accordingly, according to some embodiments of this disclosure, the method may also comprise eliminating potential collaborators from the list of potential collaborators (act 24), for example, because they declined to participate or have provided a response. However, one of the advantages of the method of this disclosure is that it may maximize the potential collaborators' responses. For example, according to some embodiments of this disclosure, the project manager will implement a Marketing Campaign (act 26) such as, described herein. For example, the Marketing Campaign may use said early collaborations for an exchange with the other prospective collaborators, which can also occur at an increasing frequency as the deadline gets closer.

Such exchange of communications is intended to encourage the undecided and the reluctant potential collaborators to participate. According to some embodiments, the tenor of said communications can be important, as they will include information about the collaborations already received from others and intended to peak their interest: For example, when the potential collaborators see that other people who they consider to be their contemporaries, for example, people in their same conditions or with the same skills have written their contributions, they will be encouraged and wonder whether they can do it as well.

In addition, according to some embodiments of this disclosure, the Marketing Campaign makes use of a subjective component of fear of being left out. Indeed, those in doubt see that the others are already involved in the project and they worry that they will be left out. For example, the idea that they will be attending the celebration and, where the participation of all the others will be recognized, but not theirs, can be part of the marketing strategy and be enough to motivate the person to participate. It is to be appreciated that the Marketing Campaign can also be structured to play on the fact that this concern of not participating will grow as time goes by and the deadline draws near.

For this reason, a growing frequency of communications can also be part of the process of this disclosure. What is not achieved by encouragement and enthusiasm can be brought about by the pressure or concern of being left out, i.e., an appeal to personal pride. Accordingly, part of the marketing to the potential collaborator can be not only the solicitation of participation, but can also involve a comparison with the quality of the other collaborations, particularly those of their own acquaintances, which may induce the potential collaborator to make a special effort towards the proposed task.

Accordingly, it is to be appreciated that the final book may contain the work of those who are enthusiastic about the ingenious idea of the book and do not procrastinate in sending their collaborations as well as those who, although also enthusiastic, can be any of slow to respond, held back by their own subjectivity, and the like.

It is to be appreciated that, according to some embodiments, the Marketing Campaign can comprise waiting for a certain period of time (act 28), e.g. X number of days, to see what additional contributions are provided. In addition, according to some embodiments, there may be a last attempt to solicit contributions, which can include a review as to whether the established deadline has occurred (act 30). If not, the project manager can send one last message to the candidates who have not yet sent their pieces (act 32), warning them that the deadline is inexorable and that that is the last notice.

According to some embodiments, as of the established deadline, the project manager in principle closes the reception of articles and proceeds to produce the layout, composition, editing and setup of the literary work with all the literary articles received. However, it is to be appreciated that according to some embodiments, exceptions can be made such as, for example, under the pretext that someone very close to the gift recipient has not sent in his/her contribution and the originator considers said collaboration essential, the project manager may grant a short grace period as a last opportunity. In such a situation, there may be messages of invitation and encouragement emphasized by personal contact by the originator with such person (act 34). It is to be appreciated that there can be more than one such person, but the number of such collaborators should be a small percentage of the general invitation.

The project manager can then undertake the setup, assembly of the product (act 36). However, it is to be appreciated that, according to some embodiments, the setup can occur anywhere in the process. In addition, according to some embodiments, the project manager substantially uses for compilation the material as received, although he may make corrections or suggest additions or ideas to an individual collaborator. However, it is to be appreciated that the project manager is not going to attempt teach the collaborators the art of writing. In particular, the herein described method is not directed to an educational method, but rather to a production method, i.e., a method for producing a personal literary work, since the contributed material will consist in opinions, stories, anecdotes, fiction, and the like, in which the gift recipient plays a part.

It is to be appreciated that there may be embodiments where the project manager does exercise his or her literary and aesthetic skills is in design of the layout of the product and preparation of the cover. For example, the project manager may contribute a title to the work intended to immediately draw the attention of the gift recipient, when he/she receives it, to the fact that it is not just any book, but his/her own custom book. It is to be appreciated that according to some embodiments of the product and method of this disclosure, some advantages are that the originator enjoys not only the satisfaction of contributing to and giving the book, as well as the reception of the book, but also of seeing his/her name on the cover, as author. In addition, other advantages are that other guests that have contributed to the work will be satisfied that they also have contributed to and may be included in the pages of the book. Accordingly, it is to be appreciated that the anticipation of this moment in the guests can be part of what moves them to participate, knowing that if they don't, they may regret it sooner or later.

According to some embodiments of the method of this disclosure, the process is completed when the finished book is delivered to the originator (act 38), for example, without delay after the final deadline. An advantage of the process is that the originator only has to wait until the day comes when the gift is to be presented to the gift recipient (act 40) such as, for example, during a party or tribute.

It is also to be appreciated that one advantage of the product of this disclosure is that the external appearance of the book can be that of a commercial book; which can be such that at first sight, it does not appear to be any more personal or different from any other books found in a book store. It is also to be appreciated that the product can include, but does not have to include, any of the following aspects which may be selected to befit the occasion, such as a deluxe binding, hard cover, soft cover, personalized covers, and the like, and that the material contributed by the collaborators does can include, but does not have to include, any of written word, pictures, drawings, and the like.

Referring again to FIG. 1, there is illustrated and described herein a flow chart that follows a chronological schedule and illustrates an exemplary sequence of acts that can be comprised in the method of this disclosure. The following description is further detail with respect to the various acts in addition to the acts described above The act 12 comprises the originator's negotiations with the prospective project manager, and signing of a Letter of Intent which may include: defining the nature of the book according to the type of event, e.g., 50th birthday of the gift recipient. The act 14 comprises establishing a deadline which will be a few days before the event that provides enough time for the editor to complete editing, layout and binding, plus a convenient additional period, so that the finished book can be delivered to the originator a few days in advance. The act 18 comprises compiling a list of relatives, friends and closely related colleagues, including, for example, any old schoolmates that may be tracked down, who will not want to miss the opportunity of reviving old memories. In addition, if the event is a birthday party, the list can also comprise the guests invited to the party.

The act 19 consists in setting up an e-mail address having the format “originator-name@project-manager-server.com” for sending out the invitations and getting around anti-spam e-mail systems, thereby enticing would-be collaborators to let the e-mail with the invitation into their e-mailboxes. The act 20 of writing the first message and sending out invitations can comprise entering a list of e-mail addresses of the prospective collaborators in a database created by the project manager for that purpose, and preparing the Invitation, as defined herein. The invitation can comprise describing the occasion and asking, in attractive terms, for the contribution of material, with a view to obtaining the highest number possible of early replies, i.e., in the next few days.

Once the first replies have been received during an initial period (act 22) which can comprise, for example, two weeks, naturally the flow of replies will begin to decline. Therefore, according to some embodiments, the method provides for implementing a Marketing Campaign (act 26), as described herein, which is intended to mobilize reluctant and hesitant invitees. According to some embodiments, the frequency of this exchange of messages can be increased gradually as the deadline draws near, for the purpose of encouraging those who have not sent any material, even appealing to a wish to avoid embarrassment, if for no other reason.

According to some embodiments, at reaching the deadline (act 30), a last notice is posted or sent (act 32), after which the project manager can choose to wait for one or two additional days (act 34) and then he or she shall go ahead with the making of the book (act 36). Before that, the short grace period may comprise acts of more personal calls to one or several of the invitees whom the originator may consider essential; where the originator himself/herself will try to obtain such collaboration(s). It is to be appreciated that the additional grace period may also comprise acts of the project manager conveniently starting the front cover and back cover design and layout (act 35), and may also comprise the act of starting to print the book. It is to be appreciated that the acts of printing the book (act 36) preferably comprise using high-quality printing materials.

It is to be appreciated that according to some embodiments of the method of this disclosure, the interactions between the project manager and collaborators, both actual or potential, may take place through various electronic, voice, and data media such as, for example, the Internet, e-mail with text attachments, fax machines, phones, wired and wireless date networks, and the like. For example, the project manager may create a web site (act 37) where the collaborators, using a secret password provided to them by the project manager (act 39), can follow the progress of the work. According to some embodiments of the method, the project manager's individual messages, such as the final encouraging messages, may include an electronic link to invite the candidate to browse the site. It is to be appreciated that the act 34, or any of the acts described herein, may also comprise updating the web site with new information provided by the collaborators (act 41) up until the act of finally assembling and delivering the book (act 36).

The act 38 can comprise delivering the book to the originator, who keeps it until the day of the event during which the gift recipient will be surprised with the gift, and during which all the guests will share his emotion. It is anticipated that typically only one book will be printed for the gift recipient, but that it will undoubtedly go from hand to hand and read and admired during the party, and thus the collaborators will be able to appreciate the outcome of their efforts. Nevertheless, any additional number of copies may be printed, such as, for example, one for the originator, although a large edition is not foreseen in view of the personal characteristics of the work.

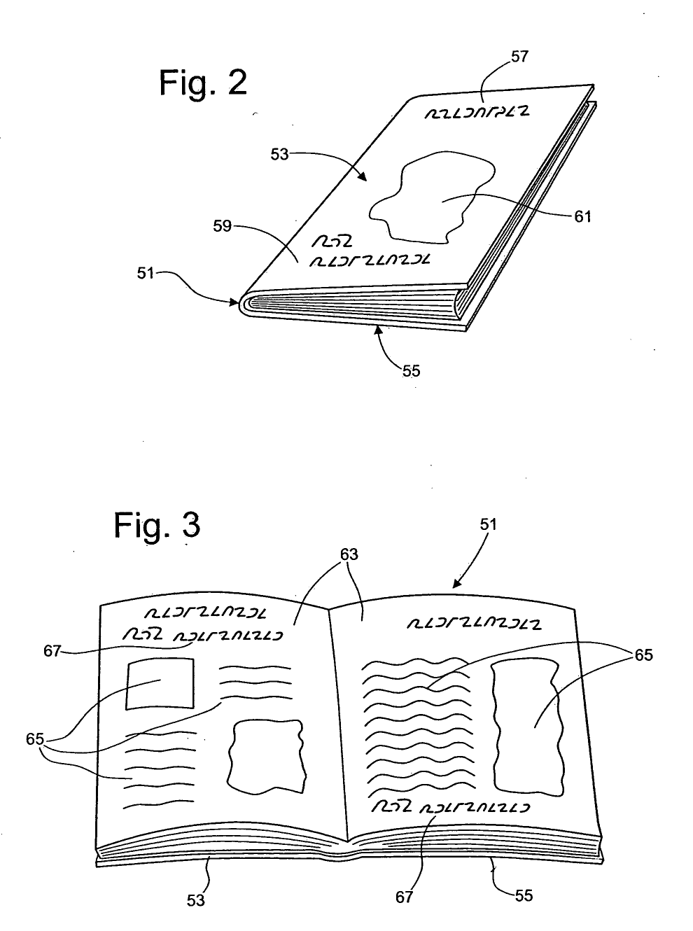

FIG. 2 illustrates an exemplary perspective view of a book 51 that can be prepared according to the herein described process. The book can comprise a finely bound cover 53, a back cover 55, a personal title 57, and the author's (i.e., the originator's) name 59 printed on the cover. The originator may be, for example, the husband or wife of the gift recipient, who will be even more thrilled at seeing his/her name on the cover of this work of high emotional and sentimental value 51. The cover 53 may also include art work to enhance the charm and beauty of the book, which may include, for example, a picture 61 of the gift recipient or of the couple.

FIG. 3 illustrates book 51 open to exemplary pages 63, each illustrating exemplary material 65 contributed by respective collaborators 67.

It is to be appreciated that some advantages of the herein described method are that it generates, in a short period of time in comparison to the time involved in the writing of typical commercial literary works, a large amount of contents of great emotional value for a given person (or group of persons) which are printed together with any available art and photographic material, and make up a book of special characteristics: it is a non-commercial edition, intended for private or semi-private distribution, luxuriously bound, consisting of a single copy (or very small number of copies), for the purpose of serving as a surprise gift (in most cases) especially tailored for that person (or group of persons), generally on occasion of a particular event or celebration involving for him/her/them.

It is to be appreciated that some advantages of the herein described product are that unlike other types of books, the content, as defined herein, of book 51 arises from the spontaneous, disinterested collaboration of individuals closely related to the person (or group of persons) to be so honored, who send in their testimonies, anecdotes, stories, etc., that will be included in a sequence suggested by the project manager or taking into account the received material's own intrinsic logic. In addition, any person willing to present this gift 51, irrespective of his/her literary skill, may be able do so because the method creates the process and resources for the persons involved to write, inspired by the occasion, following certain guidelines as to length, form and time. The method can be systematized and iterative and can be applied to many different occasions. The resulting product of this method can also be applied to a predesigned layout and can comprise design matrixes and models, and can be presented in a standardized format to which a wide variety of optionals and variations can be applied, to make of this gift a uniquely valuable object for the gift recipient and his/her close relations.

The above embodiments of the method and product have been described by way of illustration, although those skilled in the art will readily devise changes and variations with respect to the above described form, without departing from the spirit and scope of this disclosure. For example, items may be included which have not been directly produced by an invited collaborator, e.g., clippings of printed matter referring to the gift recipient or a past event intimately related to him/her. In addition, although the entire process can take place without the gift recipient knowing and the project manager not knowing him/her personally, the gift recipient may also be interviewed, for example, under a plausible pretext, which disguised interview can be then included in book 51.

Having now described some illustrative embodiments of this disclosure, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of this disclosure. Acts, elements and features discussed only in connection with one embodiment are not intended to be excluded from a similar role in other embodiments.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. A method for producing a custom literary work to be presented on a predetermined delivery date to a recipient, which recipient may be an individual or a group of individuals, comprising the acts of:
receiving from an originator an order to produce said literary work;
fixing a deadline for the reception of collaborations prior to the predetermined delivery date;
jointly with the originator, identifying and selecting a plurality of potential collaborators associated with said recipient;
sending out a general invitation to the selected potential collaborators requesting them to contribute literary pieces or other types of material related to the gift recipient;
receiving the material from at least one of said collaborators in response to said general invitation;
after the reception of material from at least one of the collaborators and before said deadline, sending a notice to at least one of the potential collaborators from whom no reply has been received as yet, informing them of the articles received from other collaborators;
repeating the previous act of sending out the notice at least once more on a date close to said deadline to the potential collaborators who have not sent anything yet;
designing the layout of the literary work with material that includes a title alluding to the gift recipient and the originator's name;
before the deadline, setting up, assembling and mounting the literary work with all the material received; and
delivering the finished literary work to said originator.

2. The method in accordance with claim 1, wherein said plurality of potential collaborators is identified and selected based on questions to said originator about the gift recipient's interests, tastes, experiences and personal peculiarities.

3. The method in accordance with claim 1, wherein the literary work is delivered to the gift recipient for his/her birthday.

4. The method in accordance with claim 1, wherein the gift recipient is a married couple and the literary work is delivered to them on occasion of a wedding anniversary of the gift recipient couple.

5. The method in accordance with claim 1, wherein said potential collaborators are selected from any of the gift recipient's close relatives, friends, colleagues, and others associated with the gift recipient.

6. The method in accordance with claim 1, further comprising an act of conducting a disguised interview with the gift recipient and including it as one of the pieces in said literary work.

7. The method in accordance with claim 1, wherein said act of sending out notices includes writing a message containing information about other collaborators who have already sent in their pieces so as to induce the addressee to create and send in his or her individual piece.

8. The method in accordance with claim 1, wherein said acts of sending out notices is iterated with greater frequency as the deadline draws near, each of the notices including a list of the collaborators who have contributed and warning the potential collaborator that he or she is about to be left out of the literary work.

9. The method in accordance with claim 8, wherein said notices comprise a reference to a web page that is available in a public computer network, the web page comprising updated information about the literary work process including information on the received pieces and the collaborators who developed them, the notice also including a password to access said web page.

10. The method in accordance with claim 8, wherein said notices are sent by e-mail and wherein said pieces are received as attachment to e-mail messages sent in reply to the notices.

11. The method in accordance with claim 8, wherein substantially simultaneously with said sending of the notices, the cover and back cover of the literary work are being designed and laid out.

12. The method in accordance with claim 8, wherein among said potential collaborators invited, there is at least one whose collaboration is desired by the said originator and from whom no piece has been received up to the deadline, and a brief grace period is granted during which said originator tries to induce him/her to collaborate.

13. A literary work obtained in accordance with the method of claim 1, wherein said literary work comprises a plurality of articles related to the gift recipient's life, experiences, interests and tastes, with each piece having a different author.

14. The literary work in accordance with claim 13, wherein said literary work comprises a book.

15. The literary work in accordance with claim 14, wherein said book has the appearance of a commercial book.

16. The literary work in accordance with claim 14, wherein said book comprises deluxe binding.

17. The literary work in accordance with claim 14, wherein said book has a cover bearing a title referred to the gift recipient, art work regarding the gift recipient, and an identification of the originator as the book's author.

18. The literary work in accordance with claim 13, wherein said articles comprise any of testimonies, anecdotes, stories, or artwork, written by said authors.

19. A custom literary work comprising a plurality of articles related to the recipient's life, experiences, interests and tastes, with each article having a different author.

20. The custom literary work in accordance with claim 19, wherein said literary work comprises a book.

21. The custom literary work in accordance with claim 20, wherein the book is constructed and arranged to have the appearance of a commercial book.

22. The custom literary work in accordance with claim 21, wherein said book comprises a deluxe binding.

23. The custom literary work in accordance with claim 20, wherein said book has a cover bearing a title referencing the recipient, art work regarding the recipient, and an identification of the originator as the book's author.

24. The custom literary work in accordance with claim 19, wherein the articles comprise any of testimonies, anecdotes, stories, or artwork, prepared at least in part by the authors.

25. A method for producing a custom literary work to be presented on a predetermined delivery date to a recipient, comprising the acts of:
receiving an order to produce said literary work;
fixing a deadline for the reception of collaborations prior to the predetermined delivery date;
identifying and selecting a plurality of potential collaborators associated with said recipient;
sending a general invitation to the potential collaborators requesting them to contribute material related to the recipient;
sending a notice to at least one of the potential collaborators from whom no reply has been received;
receiving material from at least one of said collaborators;
setting up and assembling the literary work with at least some of the material received; and
delivering the finished literary work.

26. The method in accordance with claim 25, further comprising repeating the act of sending out the notice to the potential collaborators who have not sent anything yet, at least once more on a date close to said deadline.

27. The method in accordance with claim 25, wherein the act of setting up the literary work comprises designing a title alluding to the gift recipient.

28. The method in accordance with claim 25, wherein the act of setting up the literary work comprises designing a title alluding to an originator's name.

29. The method in accordance with claim 25, wherein the act of identifying and selecting a plurality of potential collaborators comprises posing questions to an originator of the literary work.

30. The method in accordance with claim 29, wherein the act of posing questions to an originator of the literary work comprises posing questions about any of the recipient's interests, tastes, experiences and personal peculiarities

31. The method in accordance with claim 25, wherein the act of delivering the finished literary work comprises delivery the literary work to the recipient.

32. The method in accordance with claim 31, wherein the act of delivering the finished literary work comprises delivery the literary work as a gift for a special occassion.

33. The method in accordance with claim 25, wherein the act of delivering the finished literary work comprises delivery the literary work to the originator.

34. The method in accordance with claim 25, further comprising an act of conducting an interview with the recipient and including it as one of the pieces in the literary work.

35. The method in accordance with claim 25, wherein the act of sending a notice to at least one of the potential collaborators from whom no reply has been received includes providing information about other collaborators who have already sent in their pieces so as to induce the addressee to create and send in his or her contribution.

36. The method in accordance with claim 25, wherein the act of sending a notice to at least one of the potential collaborators from whom no reply has been received comprises sending the notice with greater frequency as the deadline draws near.

37. The method in accordance with claim 25, wherein the act of sending the general invitation or the notice comprises sending a reference to a web page comprising updated information about the literary work.

38. The method in accordance with claim 37, wherein the act of sending the reference to a web page comprises sending a password to access said web page.

39. The method in accordance with claim 25, wherein the act of sending the general invitation or the notice comprises sending the invitation or the notice by e-mail.

40. The method in accordance with claim 39, wherein the act of receiving material from at least one of said collaborators comprising receiving the pieces as an attachment to e-mail message sent in reply to the notice or the general invitation.

41. The method in accordance with claim 25, wherein the act of sending a notice to at least one of the potential collaborators comprises substantially simultaneously designing the cover of the literary work.

42. The method in accordance with claim 25, wherein the act of sending a notice to at least one of the potential collaborators comprises providing brief grace period during which the potential collaborator is urged to participate.

43. The method in accordance with claim 1, wherein said act of sending out a general invitation includes previously setting up an e-mail address including a name substantially known or recognized by all potential collaborators.

44. The method in accordance with claim 43, wherein said e-mail address includes a name of said originator.
